(19) United States
(12) Patent Application Publication
(10) Pub. No.: US 2026/0208528 A1
(43) Pub. Date: Jul. 23, 2026

(54) REPLACEMENT TRAILER AXLE SPINDLE FOR VEHICLE TRAILER AXLE AND INSTALLATION METHOD

(71) Applicant: TrailerApp.com LLC, Cypress, TX (US)

(72) Inventor: Alton Lewis Shelton, III, Cypress, TX (US)

(21) Appl. No.: 19/456,045

(22) Filed: Jan. 22, 2026

Related U.S. Application Data
(60) Provisional application No. 63/748,049, filed on Jan. 22, 2025.

(51) Int. Cl. B60B 35/04

(52) U.S. Cl. CPC B60B 35/04; B60B 2320/10

(57) ABSTRACT

A light-to-medium duty replacement trailer axle spindle for a light-to-medium duty vehicle trailer axle and method of installing the light-to-medium duty replacement trailer axle spindle for a light-to-medium duty vehicle trailer axle are set forth. The light-to-medium duty replacement trailer axle spindle, per an implementation, includes an insertion sleeve configured to be installed into a light-to-medium duty vehicle trailer axle. A bevel portion of the light-to-medium duty replacement trailer axle spindle is configured to form a welding surface by which the light-to-medium duty replacement trailer axle spindle may be attached to the light-to-medium duty vehicle trailer axle.

### CROSS-REFERENCE TO RELATED APPLICATION

This application claims the benefit of U.S. Provisional Patent Application No. 63/748,049, with a filing date of Jan. 22, 2025, the contents of which are hereby incorporated by reference in their entirety.

### TECHNICAL FIELD

The present disclosure relates generally to trailer axle spindles and, more particularly, to replacement trailer axle spindles for light-to-medium duty vehicle trailer axles.

### BACKGROUND

Vehicle trailers are typically towed or otherwise pulled by vehicles such as automotive trucks. They can be used to haul cargo or other loads behind the vehicle for recreational, work, and commercial purposes, among other possibilities. Vehicle trailers come in different capacities and are commonly classified based on the load they are intended to carry. Light-duty vehicle trailers, for instance, can have a pulling capacity of about 12,000 pounds or less, and medium-duty vehicle trailers can have a pulling capacity of about 40,000 pounds or less, according to certain classifications.

Trailer axle spindles are equipped in vehicle trailers and rotate as wheels of the vehicle trailers traverse the underlying ground. Trailer axle spindles often reside at ends of larger trailer axles and drive rotation of the vehicle trailer's wheels. When trailer axle spindles are worn, damaged, or otherwise require replacement, it is not uncommon for the larger trailer axles to be subject to replacement with them. But replacement costs can be high, and sometimes the trailer axles are not worn, damaged, or in need of replacement themselves.

### SUMMARY

In an embodiment, a light-to-medium duty replacement trailer axle spindle for a light-to-medium duty vehicle trailer axle may include a main body with a bevel portion and an insertion sleeve portion. The main body extends axially between a proximal end and a distal end. The bevel portion is distanced from the proximal end and adjoins the insertion sleeve portion, and is tapered in diameter in an axially-inward direction with respect to the vehicle trailer axle and toward the proximal end. An outer surface of the bevel portion constitutes a welding surface for a weld attachment upon installation of the light-to-medium duty replacement trailer axle spindle to the light-to-medium duty vehicle trailer axle. The insertion sleeve portion adjoins the proximal end. The weld attachment resides at least adjacent the welding surface and outer surface of the bevel portion, and the insertion sleeve portion is received within the light-to-medium duty vehicle trailer axle and an overlapping axial arrangement is established therebetween.

In an embodiment, a method of installation of a light-to-medium duty replacement trailer axle spindle to a light-to-medium duty vehicle trailer axle is set forth. The method may involve inserting an insertion sleeve portion of the light-to-medium duty replacement trailer axle spindle within the light-to-medium duty vehicle trailer axle. The light-to-medium duty replacement trailer axle spindle and the light-to-medium duty vehicle trailer axle may be self-centered with respect to each other upon full insertion of the insertion sleeve portion. The bevel portion of the light-to-medium duty replacement trailer axle spindle and a terminal end portion of the light-to-medium duty vehicle trailer axle may engage to facilitate the self-centering.

In an embodiment, a light-to-medium duty replacement trailer axle spindle for a light-to-medium duty vehicle trailer axle may include a main body that is cylindrical in shape and extends axially between an axially outwardly-most and distal end and an axially inwardly-most and proximal end. The main body has a bevel portion and an insertion sleeve portion. The bevel portion is tapered in diameter in an axially-inward direction with respect to the vehicle trailer axle and toward the proximal end. An outer surface of the bevel portion constitutes a welding surface for a weld attachment upon installation of the light-to-medium duty replacement trailer axle spindle to the light-to-medium duty vehicle trailer axle. The insertion sleeve portion extends axially between the bevel portion and the proximal end, and has a uniform diameter over its axial extent between the bevel portion and the proximal end. Upon installation of the light-to-medium duty replacement trailer axle spindle to the light-to-medium duty vehicle trailer axle, the weld attachment resides at least adjacent the welding surface and outer surface of the bevel portion, and the insertion sleeve portion is at least partially received within a hallow portion the light-to-medium duty vehicle trailer axle and an overlapping axial arrangement is established therebetween.

### BRIEF DESCRIPTION OF THE DRAWINGS

The present disclosure will become more fully understood from the detailed description given below and the accompanying drawings, which are given by way of illustration only, and do not limit the present disclosure, and wherein:

FIG. 1 is a side view of an embodiment of a light-to-medium duty vehicle trailer axle and replacement trailer axle spindle assembly;

FIG. 2 is a perspective view of an embodiment of a light-to-medium duty replacement trailer axle spindle;

FIG. 3 is a side view of the light-to-medium duty replacement trailer axle spindle;

FIG. 4 is an enlarged view of the light-to-medium duty replacement trailer axle spindle and the light-to-medium duty vehicle trailer axle in the assembled state, with the light-to-medium duty vehicle trailer axle shown partially transparent for demonstrative purposes;

FIG. 5 is sectional view of the light-to-medium duty replacement trailer axle spindle and the light-to-medium duty vehicle trailer axle; and

FIG. 6 is a block diagram of an embodiment of a method of installation of a light-to-medium duty replacement trailer axle spindle to a light-to-medium duty vehicle trailer axle.

### DETAILED DESCRIPTION

Referring generally to the drawings, an embodiment of a light-to-medium duty replacement trailer axle spindle (hereafter, “replacement trailer spindle”) is depicted and described, as well as an embodiment of a method of installation of the replacement trailer spindle. The replacement trailer spindle, in general, can be installed with a light-to-medium duty vehicle trailer axle (hereafter, “trailer axle”) of a light-to-medium duty vehicle trailer. The phrase “light-to-medium duty,” as used herein, is intended to encompass spindles, axles, and/or trailers having a light-duty and/or a medium-duty pulling capacity classification of approximately 12,000 pounds or less for light-duty applications and/or approximately 40,000 pounds or less for medium-duty applications; the phrase is not meant to encompass heavy-duty spindles, axles, and/or trailers having a pulling capacity that is greater than that of light-duty and medium-duty spindles, axles, and/or trailers. Further, and unlike past trailer axles and spindles, the replacement trailer spindle set forth herein has self-centering capabilities that furnishes approximate centering of the replacement trailer spindle and the trailer axle with respect to each other when the components are brought together amid installation procedures. The self-centering capabilities have been shown to ease centering and installation for proper replacement and functioning of the assembled components, and serves to facilitate and ready the replacement trailer spindle and trailer axle for subsequent welding. Also unlike past trailer axles and spindles, the replacement trailer spindle herein has load-bearing capabilities that furnishes enhanced robustness of the assembled and installed components for proper functioning thereof. Overall, a more effective and efficient replacement trailer spindle and method of installation is provided. Still, a particular embodiment of the replacement trailer spindle and method of installation may exhibit only one, or a combination of, the advancements set forth herein, none of the advancements, or yet other advancements that go unmentioned.

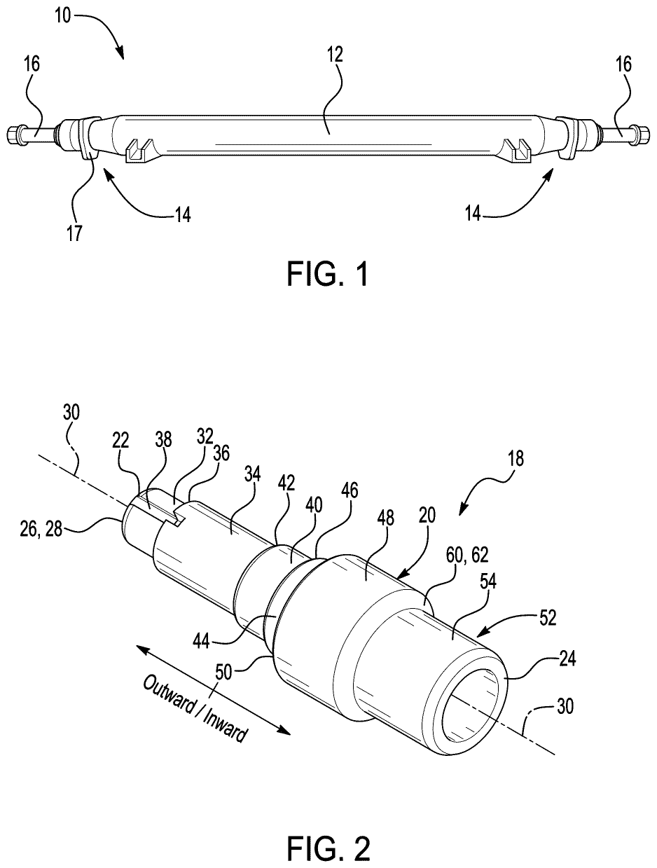

With reference to FIG. 1, an example of a light-to-medium duty vehicle trailer axle 10 (hereafter, “trailer axle”) is presented. The trailer axle 10 has a shaft 12 that spans the width of an accompanying light-to-medium duty vehicle trailer (hereafter, “trailer”) to partially support the weight of the trailer and any cargo carried thereon. At each end 14 of the shaft 12, a spindle 16, a hub assembly (unshown), and a wheel assembly (unshown) may be mounted co-axially with the shaft 12. The spindle 16 extends outward from the shaft 12 to support the hub and wheel assemblies. The spindle 16 may be affixed to the shaft 12 by a weld, nut, bolt, fastener, or by other methods known in the art. Each hub assembly may include a housing that contains one or more wheel bearings to facilitate smooth rotation of the hub about the spindle 16. Each wheel assembly may include a rim, a tire, and fasteners to secure the rim and tire to the hub assembly. One or more flanges 17 may be positioned on the shaft 12 to mount components such as suspension parts, brake parts, or other trailer parts to the trailer axle 10.

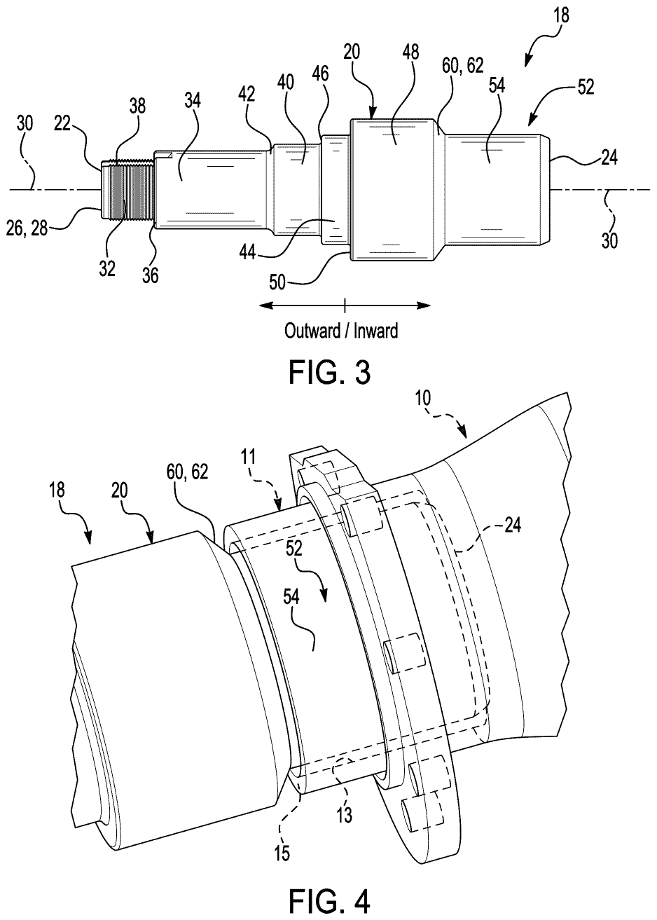

With reference now to FIGS. 2 and 3, an embodiment of a light-to-medium duty replacement trailer axle spindle 18 (hereafter, “replacement trailer spindle”) is presented. The replacement trailer spindle 18 can be employed to replace an obsolete or otherwise unwanted spindle of the trailer axle 10, which could be the original-equipment spindle, as an example. Obsolescence can be a consequence of wear and/or damage and/or other causes. The replacement trailer spindle 18 can have various designs, constructions, and components in various embodiments depending in part or more upon its intended application and use. In the embodiment of FIGS. 2 and 3, the replacement trailer spindle 18 has a design and construction that makes it suitable and compatible with a number of different types, kinds, and sizes of trailer axles that can be produced from different trailer and trailer axle manufacturers. The replacement trailer spindle 18 accommodates variations in design and construction of trailer axles.

In the embodiment of FIGS. 2 and 3, axially-inward and axially-outward directions are represented for demonstrative purposes. The axially-inward and axially-outward directions are with respect to the trailer axle 10 and with respect to the replacement trailer spindle 18. The replacement trailer spindle 18 has a main body 20 that extends axially between an axially outwardly-most and distal end 22 and an axially inwardly-most and proximal end 24. The main body 20 has a general overall cylindrical shape with portions of different diameters. At the distal end 22, an outer end 26 having an outer end surface 28 is cylindrical in shape and is coaxial with an axis 30 centered with the replacement trailer spindle 18. A threaded section 32 extends circumferentially about the axis 30 and axially-inwardly along the axis 30. The threaded section 32 is configured to receive a nut of a hub or wheel assembly to securely mount the hub or wheel assembly to the replacement trailer spindle 18. Farther axially-inwardly from the outer end 26, per this embodiment, a first bearing surface 34 is provided. A first stop surface 36 is located between the first bearing surface 34 and the threaded section 32. The first stop surface 36 provides structure from which the hub or wheel nut of the hub or wheel assembly may be tightened against to secure the hub or wheel assembly to the replacement trailer spindle 18. Further, per this embodiment, a groove 38, a second bearing surface 40, a second stop surface 42, a seal surface 44, a third stop surface 46, a support surface 48, and a fourth stop surface 50 are provided. Still, in other embodiments, other designs, constructions, components, and/or surfaces can be provided for the replacement trailer spindle 18.

Furthermore, in this embodiment and with reference now to FIGS. 2, 3, and 5, the main body 20 of the replacement trailer spindle 18 has an insertion sleeve portion 52 and a bevel portion 60. The insertion sleeve portion 52 is inserted and received within a hollow region of the trailer axle 10 and enables load-bearing therebetween upon assembly and installation for enhanced robustness and proper functioning and use. The insertion sleeve portion 52 extends axially between the bevel portion 60 and the proximal end 24. The insertion sleeve portion 52 immediately adjoins the bevel portion 60 and immediately adjoins the proximal end 24, with no intervening constructions or components residing therebetween, per this embodiment. Relative to the main body 20, the insertion sleeve portion 52 constitutes a terminal end portion and region of the main body 20 at the proximal end 24. Furthermore, the insertion sleeve portion 52 has a consistent and uniform diameter over its axial extent between the bevel portion 60 and the proximal end 24. The overall axial length and extent of the insertion sleeve portion 52 measured between the bevel portion 60 and the proximal end 24 can vary in value, and according to this embodiment can range between approximately 1 inch and approximately 4 inches; still, other ranges are possible in other embodiments. Qualitatively, the overall axial length and extent of the insertion sleeve portion 52 can be at least approximately twenty percent (20%) of an overall axial length and extent of the main body 20 measured between the distal and proximal ends 22, 24, or can range between approximately 10% and 40% of the overall axial length and extent of the main body 20; still, other percentage values and ranges are possible in other embodiments. These values and percentages have been shown to facilitate the load-bearing capabilities enabled by the insertion sleeve portion 52.

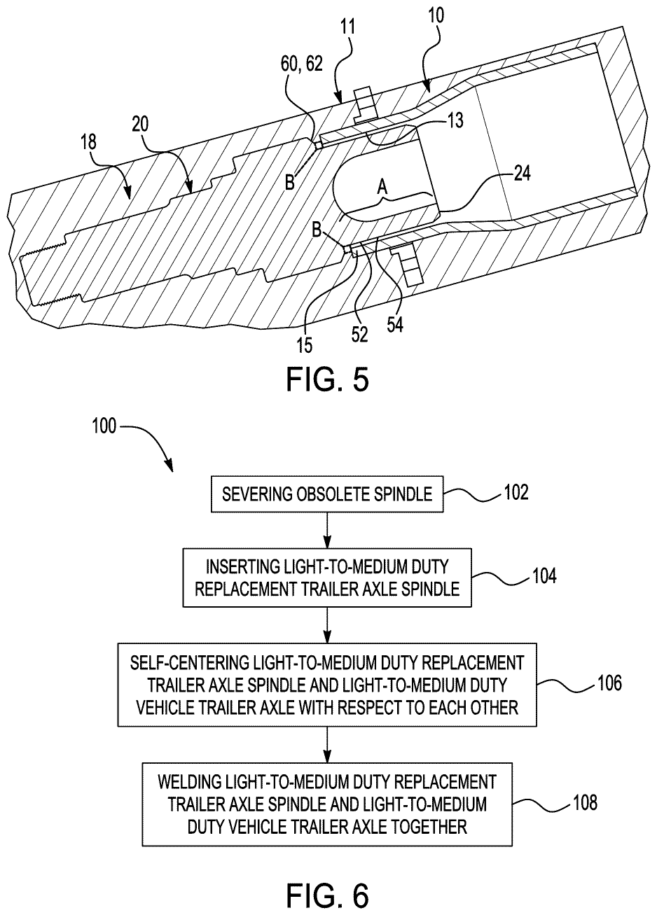

Further, an outer surface 54 of the insertion sleeve portion 52 constitutes a load-bearing surface thereof. Upon assembly and installation of the replacement trailer spindle 18 at an end region 11 of the trailer axle 10—and with reference now to FIGS. 4 and 5—the load-bearing surface 54 can come into abutment with a confronting inner surface 13 of the trailer axle 10. The abutment, if it indeed occurs, serves to bear and endure any loads that may be exerted therebetween. The abutment can be surface-to-surface abutment, or an abutment of lesser area, per an embodiment. Moreover, an overlapping arrangement OA is established between the insertion sleeve portion 52 and the end region 11 of the trailer axle 10 when assembled and installed together. The overlapping axial arrangement A contributes to the load-bearing capabilities that enhances robustness and helps ensure proper functioning and use. The overlapping axial arrangement A is established by the depth of insertion and receipt of the insertion sleeve portion 52 within the end region 11. In an embodiment, the depth of insertion and receipt is established via abutment made between a terminal end 15 of the end region 11 and the bevel portion 60; still, in another embodiment the terminal end 15 and bevel portion 60 need not necessarily make abutment. The terminal end 15 can be planar in configuration. The overlapping axial arrangement A exhibits an overlapping axial value that can vary, and according to this embodiment can range between approximately 1 inches and approximately 4 inches; still, other ranges are possible in other embodiments. Qualitatively, the overlapping axial arrangement A and overlapping axial value established between the insertion sleeve portion 52 and end region 11 can be at least approximately twenty percent (20%) of the overall axial length and extent of the main body 20, or can range between approximately 10% and 40% of the overall axial length and extent of the main body 20; still, other percentage values and ranges are possible in other embodiments. These values and percentages have been shown to facilitate the load-bearing capabilities enabled by the insertion sleeve portion 52. Lastly, as demonstrated in the sectional view of FIG. 5, the insertion sleeve portion 52 can have a hollow construction.

The bevel portion 60 enables self-centering of the replacement trailer spindle 18 and the trailer axle 10 at the end region 11 with respect to each other when the two components are brought together and the insertion sleeve portion 52 is inserted into the end region 11. The self-centering capabilities effect approximate, or more precise, centering of the components relative to each other for ease of installation and proper positioning for subsequent welding and for subsequent functioning. The self-centering capabilities occur by nature of the slant of the bevel portion 60, and as a consequence of abutment between the bevel portion 60 and the terminal end 15 of the end region 11 of the trailer axle 10. In this respect, the centering is automatic. The replacement trailer spindle 18 and trailer axle 10 are thereby coaxial and concentric with their respective center axes in approximate alignment. The bevel portion 60 constitutes a self-centering portion of the replacement trailer spindle 18. With continued reference to FIGS. 2-5, in this embodiment the bevel portion 60 is set back and positioned a distance from the proximal end 24 via the insertion sleeve portion 52. An outer surface 62 of the bevel portion 60 is slanted and tapered in diameter. The taper furnishes a reducing diameter in the axially-inward direction and toward the proximal end 24. An angle of the slant of the bevel portion 60 relative to the axis 30 is non-zero and non-perpendicular, and is an acute angle according to this embodiment. The angle can be approximately 37 degrees (°), and can range between approximately 30° and approximately 45° degrees, per various embodiments; still, other values and ranges are possible in other embodiments. These values and ranges have been shown to facilitate the self-centering capabilities enabled by the bevel portion 60.

Further, a welding process is executed at an interfacial region established between and adjacent the bevel portion 60 and the terminal end 15 of the trailer axle 10 for fixing the replacement trailer spindle 18 and the trailer axle 10 together. The welding process occurs after self-centering takes place. The type of welding carried out can vary and, according to this embodiment, can be a MIG type of welding or a stick type of welding or another type of welding. The outer surface 62 of the bevel portion 60 constitutes a welding surface of the replacement trailer spindle 18. A weld attachment B (FIG. 5) resides adjacent and at the welding surface and adjacent and at the outer surface 62 of the bevel portion 60. The weld attachment B can span wholly circumferentially around the interfacial region, per this embodiment.

With reference now to FIG. 6, an embodiment of a method and procedure of installation of the replacement trailer spindle 18 to the trailer axle 10 is depicted in block diagrammatic form. The method of installation is denoted by reference numeral 100. The method of installation 100 can involve various steps performed in various sequences. The method can have more, less, and/or different steps than those presented in FIG. 6. According to the embodiment of the figure, a step 102 involves severing and removing the obsolete and to-be-replaced spindle from the trailer axle 10. Obsolescence can be a consequence of wear and/or damage and/or other causes. Severing is intended to ready the trailer axle 10 for subsequent receipt of the replacement trailer spindle 18. A step 104 involves inserting the replacement trailer spindle 18 within and into the trailer axle 10. The insertion sleeve portion 52 is received within the hollow region of the trailer axle 10. Load-bearing capabilities are hence ready for enablement upon insertion in this step. In a further step 106, approximate (or more precise) self-centering occurs between the replacement trailer spindle 18 and the trailer axle 10 with respect to each other. Self-centering is via the bevel portion 60, as described. Upon full insertion, abutment occurs between the bevel portion 60 and the terminal end 15 of the end region 11 of the trailer axle 10. Lastly, per this embodiment, a step 108 involves welding the replacement trailer spindle 18 and the trailer axle 10 together. The welding, as described, can be performed at the interfacial region established between and adjacent the bevel portion 60 and the terminal end 15 of the trailer axle 10.

As used herein, the terms “general” and “generally” and “approximately” are intended to account for the inherent degree of variance and imprecision that is often attributed to, and often accompanies, any design and manufacturing process, including engineering tolerances—and without deviation from the relevant functionality and intended outcome—such that mathematical precision and exactitude is not implied and, in some instances, is not possible. In other instances, the terms “general” and “generally” and “approximately” are intended to represent the inherent degree of uncertainty that is often attributed to any quantitative comparison, value, and measurement calculation, or other representation.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

Those of skill in the art will understand that modifications (additions and/or removals) of various components of the substances, formulations, apparatuses, methods, systems, and embodiments described herein may be made without departing from the full scope and spirit of the present disclosure, which encompass such modifications and any and all equivalents thereof.

What is claimed is:

1. A light-to-medium duty replacement trailer axle spindle for a light-to-medium duty vehicle trailer axle, the light-to-medium duty replacement trailer axle spindle comprising:
a main body extending axially between a proximal end and a distal end, said main body having a bevel portion and an insertion sleeve portion;
said bevel portion distanced from said proximal end and adjoining said insertion sleeve portion, said bevel portion tapered in diameter in an axially-inward direction with respect to the vehicle trailer axle and toward said proximal end, an outer surface of said bevel portion constituting a welding surface for a weld attachment upon installation of the light-to-medium duty replacement trailer axle spindle to the light-to-medium duty vehicle trailer axle; and
said insertion sleeve portion adjoining said proximal end;
wherein, upon installation of the light-to-medium duty replacement trailer axle spindle to the light-to-medium duty vehicle trailer axle, the weld attachment resides at least adjacent said welding surface and outer surface of said bevel portion, and said insertion sleeve portion is received within the light-to-medium duty vehicle trailer axle and an overlapping axial arrangement is established therebetween.

2. The light-to-medium duty replacement trailer axle spindle as set forth in claim 1, wherein an outer surface of said insertion sleeve portion constitutes a load-bearing surface that, upon installation of the light-to-medium duty replacement trailer axle spindle to the light-to-medium duty vehicle trailer axle, said load-bearing surface is abuttable with a confronting surface of the light-to-medium duty vehicle trailer axle and bears loads exerted therebetween.

3. The light-to-medium duty replacement trailer axle spindle as set forth in claim 1, wherein said bevel portion is a self-centering portion of said main body that approximately centers the light-to-medium duty replacement trailer axle spindle and the light-to-medium duty vehicle trailer axle with respect to each other upon installation of the light-to-medium duty replacement trailer axle spindle to the light-to-medium duty vehicle trailer axle.

4. The light-to-medium duty replacement trailer axle spindle as set forth in claim 1, wherein said overlapping axial arrangement between said insertion sleeve portion and the light-to-medium duty vehicle trailer axle establishes an overlapping axial value that ranges between approximately ten percent (10%) and approximately forty percent (40%) of an overall axial length of said main body taken between said proximal end and said distal end.

5. The light-to-medium duty replacement trailer axle spindle as set forth in claim 1, wherein said overlapping axial arrangement between said insertion sleeve portion and the light-to-medium duty vehicle trailer axle establishes an overlapping axial value that ranges between approximately 1 inch and approximately 4 inches.

6. The light-to-medium duty replacement trailer axle spindle as set forth in claim 1, further comprising a threaded section configured to receive a nut of a hub or wheel assembly.

7. The light-to-medium duty replacement trailer axle spindle as set forth in claim 6, further comprising a bearing surface and a stop surface between said bearing surface and said threaded section, wherein said stop surface is configured to provide structure from which the hub or wheel nut of the hub or wheel assembly is tightened against.

8. The light-to-medium duty replacement trailer axle spindle as set forth in claim 1, wherein said insertion sleeve portion is hollow in construction.

9. The light-to-medium duty replacement trailer axle spindle as set forth in claim 1, wherein said bevel portion has a slant with an angle between approximately 30 degrees and approximately 45 degrees with respect to the axial-inward direction.

10. The light-to-medium duty replacement trailer axle spindle as set forth in claim 1, further comprising an outer end at said distal end of said main body, wherein said outer end is cylindrical in shape.

11. The light-to-medium duty replacement trailer axle spindle as set forth in claim 10, wherein said outer end has an outer end surface at said distal end of said main body.

12. A method of installation of a light-to-medium duty replacement trailer axle spindle to a light-to-medium duty vehicle trailer axle, the method of installation comprising:
inserting an insertion sleeve portion of the light-to-medium duty replacement trailer axle spindle within the light-to-medium duty vehicle trailer axle; and
approximately self-centering the light-to-medium duty replacement trailer axle spindle and the light-to-medium duty vehicle trailer axle with respect to each other upon full insertion of said insertion sleeve portion via engagement between a bevel portion of the light-to-medium duty replacement trailer axle spindle and a terminal end portion of the light-to-medium duty vehicle trailer axle.

13. The method of installation as set forth in claim 12, further comprising bearing loads exerted between the light-to-medium duty replacement trailer axle spindle and the light-to-medium duty vehicle trailer axle via engagement between said insertion sleeve portion of the light-to-medium duty replacement trailer axle spindle and a confronting portion of the light-to-medium duty vehicle trailer axle.

14. The method of installation as set forth in claim 12, further comprising welding the light-to-medium duty replacement trailer axle spindle and the light-to-medium duty vehicle trailer axle together at least adjacent said bevel portion of the light-to-medium duty replacement trailer axle spindle and the terminal end portion of the light-to-medium duty vehicle trailer axle.

15. The method of installation as set forth in claim 14, wherein welding the light-to-medium duty replacement trailer axle spindle and the light-to-medium duty vehicle trailer axle together further includes forming a weld that spans circumferentially around an interfacial region established between and adjacent said bevel portion and the terminal end portion of the light-to-medium duty vehicle trailer axle.

16. A light-to-medium duty replacement trailer axle spindle for a light-to-medium duty vehicle trailer axle, the light-to-medium duty replacement trailer axle spindle comprising:
a main body that is cylindrical in shape and extends axially between an axially outwardly-most distal end and an axially inwardly-most proximal end, said main body having a bevel portion and an insertion sleeve portion;
said bevel portion tapered in diameter in an axially-inward direction with respect to the light-to-medium duty vehicle trailer axle and toward said proximal end, an outer surface of said bevel portion constituting a welding surface for a weld attachment upon installation of the light-to-medium duty replacement trailer axle spindle to the light-to-medium duty vehicle trailer axle;
said insertion sleeve portion extends axially between said bevel portion and said axially inwardly-most proximal end and has a uniform diameter over its axial extent between said bevel portion and said axially inwardly-most proximal end; and
wherein, upon installation of the light-to-medium duty replacement trailer axle spindle to the light-to-medium duty vehicle trailer axle, the weld attachment resides at least adjacent said welding surface and outer surface of said bevel portion, and said insertion sleeve portion is at least partially received within a hollow region of the light-to-medium duty vehicle trailer axle and an overlapping axial arrangement is established therebetween.

17. The light-to-medium duty replacement trailer axle spindle as set forth in claim 16, further comprising a load-bearing surface configured to come into abutment with a confronting inner surface of the light-to-medium duty vehicle trailer axle.

18. The light-to-medium duty replacement trailer axle spindle as set forth in claim 16, wherein said bevel portion has a slant with an angle between approximately 30 degrees and approximately 45 degrees relative to the axial-inward direction.

19. The light-to-medium duty replacement trailer axle spindle as set forth in claim 16, wherein said bevel portion is a self-centering portion of said main body that approximately centers the light-to-medium duty replacement trailer axle spindle and the light-to-medium duty vehicle trailer axle with respect to each other upon installation of the light-to-medium duty replacement trailer axle spindle to the light-to-medium duty vehicle trailer axle.

20. The light-to-medium duty replacement trailer axle spindle as set forth in claim 16, wherein said overlapping axial arrangement between said insertion sleeve portion and the light-to-medium duty vehicle trailer axle establishes an overlapping axial value that ranges between approximately 1 inch and approximately 4 inches.
